(19) United States
(12) Patent Application Publication
(10) Pub. No.: US 2026/0168845 A1
(43) Pub. Date: Jun. 18, 2026

(54) CONNECTION ELEMENT FOR INFRARED VISION EQUIPMENT

(71) Applicant: SAFRAN ELECTRONICS & DEFENSE, PARIS (FR)

(72) Inventor: Pierrick LEMONNIER, MOISSY-CRAMAYEL (FR)

(21) Appl. No.: 19/124,025

(22) PCT Filed: Oct. 24, 2023
(86) PCT No.: PCT/FR2023/051669

§ 371 Date: Apr. 24, 2025

(30) Foreign Application Priority Data
Oct. 25, 2022 (FR) FR2211058

(51) Int. Cl. G01J 1/02; G01J 1/04; G02B 7/00

(52) U.S. Cl. CPC G01J 1/0252; G01J 1/0403; G02B 7/003; G02B 7/008

(57) ABSTRACT

A connecting element for infrared vision equipment may be manufactured by additive manufacturing. The connecting element includes a first part and a second part, where the first part has a first frame intended to be attached to one of two parts, and where the second part has a second frame intended to be attached to the other of the two parts. The first part has at least one first half-arm extending from the first frame along a connecting direction, where each of said at least one first half-arm has a tubular cavity housing at least one portion of a second half-arm of the second part, and where the second half-arm extends from the tubular cavity of the second frame along the connecting direction. An elastomer is interposed annularly in the tubular cavity between the first half-arm and the second half-arm.

### FIELD OF THE INVENTION

The present disclosure relates to a connecting element manufactured at least in part by additive manufacturing. It also relates to infrared vision equipment comprising such a connecting element.

### Description of Related Art

FIG. 1 schematically shows infrared vision equipment 1, for example multispectral long-range binoculars, with which to observe in darkness. The infrared vision equipment 1 comprises, arranged in an enclosure 2, an optical module 3, a detection module 4, a processing unit 5 and at least one display screen 6 intended for a user. The optical module 3 is configured for transmitting infrared radiation to the detection module 4 which in return transmits a signal to the processing unit 5. The processing unit 5 is configured for processing the signal received and for controlling said at least one display screen 6 in order to display an image corresponding to the received signal.

More precisely, the detection module 4 comprises an infrared detector and a cooling device, also designated cold machine, intended to cool the infrared detector in order to maintain the latter conventionally at a temperature below 150 K. For this purpose, using a Stirling effect cooling device comprising pistons is known. Such a cooling device generates vibrations and noise during operation, which may harm the acoustic secrecy of the infrared vision equipment.

Hence, there is a need to attenuate the vibrations and the noise generated by infrared vision equipment while also providing for the compactness thereof.

The invention aims to provide a simple, reliable and economical solution to this need.

### BRIEF SUMMARY OF THE INVENTION

Thus, the present document proposes a connecting element between two parts. The connecting element comprises a first part and a second part manufactured by additive manufacturing. The first part comprises a first frame extending along a first plane, where the first frame is intended to be attached to one of the two parts. The second part comprises a second frame extending along a second plane arranged facing the first plane, where the second frame is intended to be attached to the other of the two parts. The first part comprises at least one first half-arm extending from the first frame along a connecting direction. Each of said at least one first half-arm comprises a tubular cavity housing at least one portion of a second half-arm of the second part, where the second half-arm extends from the tubular cavity of the second frame along the connecting direction. An elastomer is interposed annularly in the tubular cavity between the first half-arm and the second half-arm.

Such a connecting element serves to offer a damping effect between the two parts, while also being compact, for example for an application in a confined environment. In fact, on the one hand, with the damping connection, between the first frame and the second frame, formed by the half-arms and the elastomer, the connecting element may attenuate possible vibrations between the two parts. On the other, producing the assembly formed by the first part and the second part of the connecting element by additive manufacturing provides the possibility of making the assembly as a single part, which serves to limit the number of components and the bulk of the connecting element for implementing the damping effect.

In particular, the first part may comprise a plurality of first half-arms each housing a second half-arm from a plurality of second half-arms of the second part. For example, the connecting element may comprise three or four first half-arms and second half-arms.

The assembly is preferably made as a single part. Made as a single part is understood to mean that the components of the assembly, in particular the first and second frames, and the half-arms are not made separately and then assembled. The second half-arm may thus be directly housed, at least in part, in the tubular cavity of the first half-arm during the production of the assembly.

Advantageously, the assembly cannot be disassembled.

The first part and the second part of the connecting element are preferably made in a metal, for example an aluminum alloy.

The elastomer (or TPU: thermoplastic polyurethane) is preferably made in an injectable type material. The hardness of the elastomer may advantageously be adjusted according to the intended damping.

The first half-arm and the second half-arm may form an assembly that cannot be disassembled.

The second half-arm may be entirely housed in the tubular cavity of the first half-arm.

The first plane and the second plane are preferably substantially parallel to each other.

The connecting direction may preferably be perpendicular to the first plane and/or the second plane.

The tubular cavity may have a substantially constant thickness between the first half-arm and the second half-arm. The elastomer may thus have a substantially constant thickness.

The tubular cavity may have a shape configured for assuring a retention of the second half-arm along the connecting direction. Different shapes may be conceived in order to allow the blocking of the second half-arm in the tubular cavity.

For example, the tubular cavity may have, at at least one end along the connecting direction, a conical shape with axis along the connecting direction and with the summit of the conical shape oriented towards the interior of the tubular cavity. The tubular cavity may, in particular, comprise such a conical shape at two opposite ends along the connecting direction. This conical shape serves to reinforce the behavior under compression of the connecting element. In fact, the conical shape makes it possible to work the connecting element in compression in the context of a stress along the connecting direction.

The tubular cavity may have a biconical shape arranged substantially in the middle of the two opposite ends of the tubular cavity along the connecting direction. This biconical shape serves to improve the behavior under compression of the connecting element.

It is possible to implement other shapes for the tubular cavity, for example a shoulder shape, a cylindrical shape, or even a spherical shape.

The first half-arm may comprise an opening passing through a wall of the first half-arm and opening on one side in the tubular cavity and on the other outside the first half-arm. With the opening, injecting the elastomer between the first half-arm and the second half-arm is easier.

The opening may be oriented radially or be inclined relative to the connecting direction. In particular, the opening may be located substantially in the middle of the tubular cavity along the connecting direction. This serves to improve the homogeneity of the filling of the tubular cavity with elastomer.

The connecting element may comprise a lattice connecting the first frame and the second frame. The lattice serves in particular as support for the production of the connecting element during manufacturing thereof by additive manufacturing.

The first part may advantageously comprise a first lattice extending from the first frame along the connecting direction and the second part may comprise a second lattice extending from the second frame along the connecting direction.

The first lattice and the second lattice may be disjoint.

More precisely, the first lattice and the second lattice result from an initial lattice connecting the first frame and the second frame, where the initial lattice is machined in order to separate the first lattice from the second lattice. The initial lattice serves in particular to support the production of the last frame between the first frame and the second frame along the direction of manufacturing by additive manufacturing. Such an initial lattice serves to make the production of the connecting element by additive manufacturing easier.

The geometry of the mesh of the lattice results in particular from a compromise between good execution of the support function of the last frame, and the mass of the lattice.

The first lattice and the second lattice may be connected to each other by a plurality of flexible blades. The flexible blades may correspond to portions of the initial lattice remaining after machining thereof. The flexible blades serve to provide a spring effect between the first frame and the second frame. The adaptation of the sizing of the flexible blades serves in particular to adjust the stiffness between the first part and the second part of the connecting element, in particular along the connecting direction. For this purpose, it is possible to adapt the number of flexible blades and the geometry of each of the flexible blades.

According to another aspect, the present disclosure relates to an equipment comprising the connecting element such as previously described, with a first part mounted on the first frame and a second part mounted on the second frame. Further, the first frame and/or the second frame may be arranged around at least one part of the first part or the second part.

According to another aspect, the present disclosure relates to an infrared vision equipment comprising the connecting element, a detection module and an optical module. The detection module is mechanically secured to one of the first frame or the second frame, in particular to the second frame and the optical module is mechanically secured to the other of the first frame or the second frame, in particular to the first frame. In this configuration, it is understood that the optical module is one of the said two parts and the detection module is the other of the said two parts.

More precisely, the detection module may comprise an infrared detector and a cooling device, where the housing of the infrared detector is attached to a housing of the cooling device in an attachment area. The first frame or the second frame of the connecting element is attached to the housing of the infrared detector or to the housing of the cooling device, preferably near the attachment zone between the housing of the infrared detector and the housing of the cooling device. The other of the first frame or the second frame is attached to the optical module, for example via a support structure.

Such infrared vision equipment has the advantage of reducing vibrations and noise, in particular generated by the cooling device, through the damping effect of the connecting element. Further, the production of the connecting element by additive manufacturing serves to limit the mass thereof and guarantee the compactness thereof.

Further, the connecting element may be arranged around at least one part of the housing of the infrared detector. The connecting element may comprise an inner bearing surface intended to bear on the housing of the infrared detector, for example for centering the housing of the infrared detector. This way the alignment between the detection module and the optical module is reinforced.

According to another aspect, the present disclosure relates to a process for additive manufacturing of the connecting element such as previously described. The process comprises the following steps:
producing by additive manufacturing the first part and the second part of the connecting element, in particular according to a process by melting on a powder bed;
injecting the elastomer in the tubular cavity between the first half-arm and the second half-arm.

When the connecting element comprises an initial lattice, the process may comprise, following injection of the elastomer, a step of separation of the initial lattice into a first lattice and a second lattice.

### BRIEF DESCRIPTION OF THE DRAWINGS

Other characteristics, details and advantages will appear upon reading the following detailed description, and analyzing the attached drawings, on which:

FIG. 1 shows schematically a view of infrared vision equipment;

FIG. 2 shows schematically a partial view of a connecting element example according to the present document mounted on a detection module;

FIGS. 3A and 3B show schematically a view of a connecting element example according to the present document and an enlarged section view of a part of the connecting element example;

FIGS. 4A and 4B show schematically a view of another connecting element example according to the present document and an enlarged section view of a part of the connecting element example;

FIG. 5 shows schematically a manufacturing process for the connecting element according to the present document.

### DETAILED DESCRIPTION OF THE INVENTION

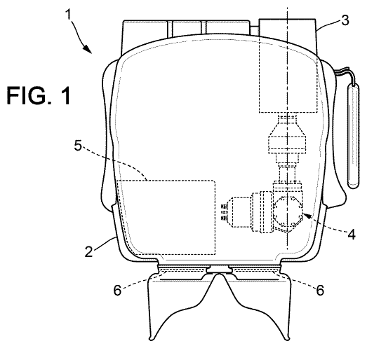

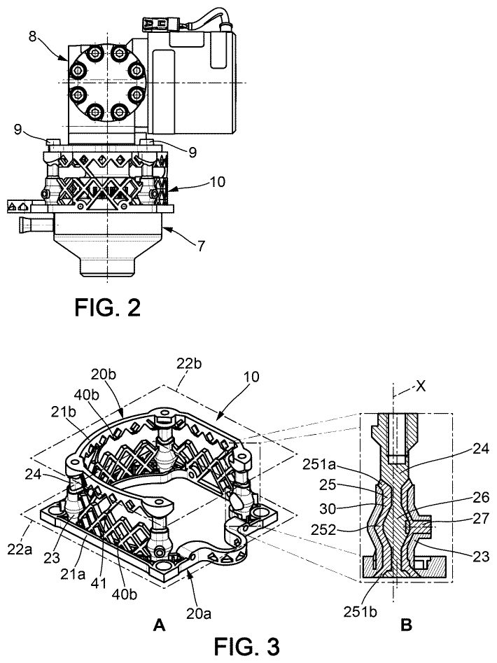

Now referring to FIG. 2 showing schematically a partial view of an example connecting element 10 according to the present document mounted to a detecting module example, preferably implemented in an infrared vision equipment such as previously described with reference to FIG. 1. The infrared vision equipment comprises in particular an optical module (not shown in FIG. 2), where the connecting element 10 is mounted both to the detection module and also to the optical module.

More precisely, the detection module may comprise an infrared detector 7 and a cooling device 8, where the housing of the infrared detector 7 is attached to a housing of the cooling device 8 in an attachment area by attachment means 9, for example by means of attachment screws. On the one hand, the connecting element 10 is attached to the housing of the infrared detector 7 or to the housing of the cooling device 8, preferably near the attachment zone between the housing of the infrared detector 7 and the housing of the cooling device 8. On the other, the connecting element 10 is attached to the optical module, for example via a support structure (not shown in FIG. 2).

Further, the connecting element 10 is in particular arranged around at least one part of the housing of the infrared detector 7. The connecting element may in particular comprise an inner bearing surface intended to bear on the housing of the infrared detector, for example for centering the housing of the infrared detector. This way the alignment between the detection module and the optical module is reinforced.

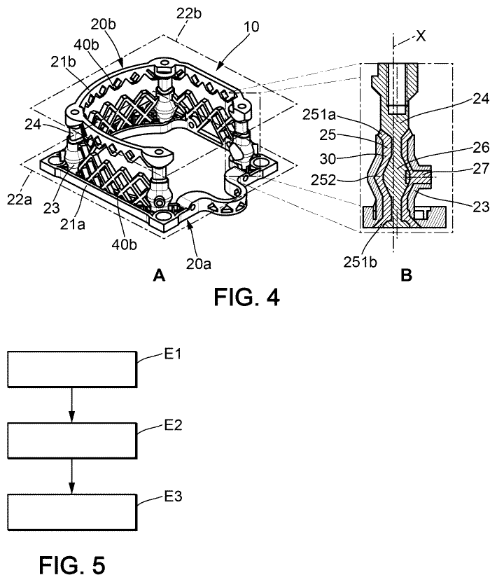

FIGS. 3A, 3B, 4A and 4B show examples of connecting element 10 according to the present document. The connecting element 10 comprises a first part 20a and a second part 20b manufactured by additive manufacturing, for example, according to a process by melting on a powder bed. The first part 20a and the second part 20b of the connecting element 10 are preferably made in a metal, for example an aluminum alloy.

The first part 20a comprises a first frame 21a extending along a first plane 22a, where the first frame 21a is intended to be attached to one of the detection module or the optical module. The second part 20b comprises a second frame 21b extending along a second plane 22b arranged facing the first plane 22a, where the second frame 21b is intended to be attached to the other of the detection module or the optical module. The first plane 22a and the second plane 22b are in particular substantially parallel to each other.

In particular, the detection module is mechanically secured to one of the first frame 21a or the second frame 21b and the optical module is mechanically secured to the other of the first frame 21a or the second frame 21b. The first frame 21a or the second frame 21b is then attached the housing of the infrared detector or to the housing of the cooling device. The other of the first frame 21a or the second frame 21b is attached to the optical module, for example via a support structure.

The first part 20a comprises at least one first half-arm 23 extending from the first frame 21 a along a connecting direction. Each of said at least one first half-arm 23 comprises a tubular cavity 25 housing at least one portion 26 of a second half-arm 24 of the second part 20b, where the second half-arm 24 extends from the tubular cavity 25 of the second frame 21 b along the connecting direction X. In other words, the first half-arm and the second half-arm form a connecting arm extending along the connecting direction X between the first frame 20a and the second frame 20b. The connecting direction X is preferably perpendicular to the first plane 22a and/or the second plane 22b.

In particular, the first part 20a may comprise a plurality of first half-arms 23 each housing a second half-arm from a plurality of second half-arms 24 of the second part 20b. For example, the connecting element 10 may comprise three or four first half-arms and second half-arms.

An elastomer 30 is interposed annularly in the tubular cavity 25 between the first half-arm 23 and the second half-arm 24. The elastomer is preferably made in an injectable type material. The hardness of the elastomer may advantageously be adjusted according to the intended damping.

With such a connecting element, a dampening effect between the detection module and the optical module can be offered, while also being compact. In fact, on the one hand, with the damping connection, between the first frame and the second frame, formed by the half-arms and the elastomer, the connecting element may attenuate possible vibrations and noises, in particular generated by the cooling device. On the other, producing the assembly formed by the first part and the second part of the connecting element by additive manufacturing provides the possibility of making the assembly as a single part, which serves to limit the number of components and the bulk of the connecting element for implementing the damping effect. The production of the connecting element by additive manufacturing thus serves to limit the mass thereof and guarantee the compactness thereof.

The assembly formed by the first part and the second part is preferably made as a single part. Made as a single part is understood to mean that the components of the assembly, in particular the first and second frames, and the half-arms are not made separately and then assembled. The second half-arm 24 may thus be directly housed, at least in part, in the tubular cavity 25 of the first half-arm 23 during the production of the assembly.

The first half-arm and the second half-arm may form an assembly that cannot be disassembled. In fact, an assembly of components connected with each other that cannot be disassembled can be produced with additive manufacturing without requiring an additional assembly step. This way the mass and bulk of the connecting element can be reduced, production made easier and the associated manufacturing costs reduced.

The second half-arm 24 may be entirely housed in the tubular cavity 25 of the first half-arm 23.

The tubular cavity 25 may in particular have a substantially constant thickness between the first half-arm 23 and the second half-arm 24. The elastomer may thus have a substantially constant thickness.

The tubular cavity 25 may have a shape configured for assuring a retention of the second half-arm 24 along the connecting direction X. Different shapes may be conceived in order to allow the blocking of the second half-arm in the tubular cavity.

For example, the tubular cavity 25 may have, at at least one end along the connecting direction X, a conical shape 251a with axis along the connecting direction X and with the summit of the conical shape oriented towards the interior of the tubular cavity 25. The tubular cavity 25 may, in particular, comprise such a conical shape 251a, 251b at two opposite ends along the connecting direction. This conical shape serves to reinforce the behavior under compression of the connecting element 10. In fact, the conical shape makes it possible to work the connecting element in compression in the context of a stress along the connecting direction X.

The tubular cavity 25 may have a biconical shape 252 arranged substantially in the middle of the two opposite ends of the tubular cavity 25 along the connecting direction X. This biconical shape serves to improve the behavior under compression of the connecting element 10.

It is possible to implement other shapes for the tubular cavity 25, for example a shoulder shape, a cylindrical shape, or even a spherical shape.

The first half-arm 23 may comprise an opening 27 passing through a wall of the first half-arm 23 and opening on one side in the tubular cavity 25 and on the other outside the first half-arm 23. With the opening 27, injecting the elastomer between the first half-arm 23 and the second half-arm 24 is easier.

The opening 27 may be oriented radially (as shown in FIGS. 3B and 4B) or be inclined relative to the connecting direction X. In particular, the opening 27 may open substantially in the middle of the tubular cavity 25 along the connecting direction X. This serves to improve the homogeneity of the filling of the tubular cavity with elastomer. In fact, during injection of the elastomer, it may flow into opposite directions along the connecting direction X.

The connecting element 10 may comprise a lattice connecting the first frame 21a and the second frame 21b. The lattice serves in particular as support for the production of the connecting element during manufacturing thereof by additive manufacturing.

Alternatively, the first part 20a of the connecting element 10 may comprise a first lattice 40a extending from the first frame 21a along the connecting direction X and the second part 20b may comprise a second lattice 40b extending from the second frame 21b along the connecting direction X.

More precisely, the first lattice 40a and the second lattice result from an initial lattice connecting the first frame and the second frame, where the initial lattice is machined in order to separate the first lattice from the second lattice. The initial lattice serves in particular to support the production of the last frame between the first frame and the second frame along the direction of manufacturing by additive manufacturing. Such an initial lattice serves to make the production of the connecting element by additive manufacturing easier. The geometry of the mesh of the lattice results in particular from a compromise between good execution of the support function of the last frame, and the mass of the lattice.

As shown in FIG. 3a, the first lattice 40a and the second lattice 40b may be connected to each other by a plurality of flexible blades 41. The flexible blades may correspond to portions of the initial lattice remaining after machining thereof. The flexible blades serve to provide a spring effect between the first frame and the second frame, which makes it possible to further attenuate the vibrations and the noises between the detection module and the optical module.

The adaptation of the sizing of the flexible blades serves in particular to adjust the stiffness between the first part and the second part of the connecting element, in particular along the connecting direction. For this purpose, it is possible to adapt the number of flexible blades and the geometry of each of the flexible blades.

Alternatively, as shown in FIG. 4A, the first lattice 40a and the second lattice 40b may be disjoint.

According to another aspect shown in FIG. 5, the present disclosure relates to a process for additive manufacturing of the connecting element such as previously described. The process comprises the following steps:
producing E1 by additive manufacturing the first part 20a and the second part 20b of the connecting element 10,
injecting E2 the elastomer 30 in the tubular cavity 25 between the first half-arm 23 and the second half-arm 24.

The process may comprise, following injecting E2 the elastomer, a step of separating E3 the initial lattice into a first lattice and a second lattice.

1. Infrared vision equipment (1) comprising:
a connecting element (10) between two parts where the connecting element (10) comprises a first part (20a) and a second part (20b) manufactured by additive manufacturing, where the first part (20a) comprises a first frame (21a) extending along a first plane (22a), where the first frame (21a) is intended to be attached to one of the two parts, and where the second part (20b) comprises a second frame (21b) extending along a second plane (22b) arranged facing the first plane (22a), where the second frame (21b) is intended to be attached to the other of the two parts,
where the first part (20a) comprises at least one first half-arm (23) extending from the first frame (21a) along a connecting direction (X), where each of said at least one first half-arm (23) comprises a tubular cavity (25) housing at least one portion (26) of a second half-arm (24) of the second part (20b), and where the second half-arm (24) extends from the tubular cavity (25) of the second frame (21b) along the connecting direction (X),
where an elastomer (30) is interposed annularly in the tubular cavity (25) between the first half-arm (23) and the second half-arm (24),
where the equipment (1) comprises an optical module (3) and a detection module (4), where the detection module is mechanically secured to one of the first frame (21a) or the second frame (21b) and the optical module is mechanically secured to the other of the first frame (21a) or the second frame (21b).

2. The infrared vision equipment (1) according to claim 1, wherein the tubular cavity (25) has a shape configured for assuring a retention of the second half-arm (24) along the connecting direction (X).

3. The infrared vision equipment according to claim 1, wherein the tubular cavity (25) has, at at least one end along the connecting direction (X), a conical shape (251a, 251b) with axis along the connecting direction (X) and with a summit of the conical shape (251a, 251b) oriented towards an interior of the tubular cavity (25).

4. The infrared vision equipment according to claim 1, wherein the first half-arm (23) comprises an opening (27) passing through a wall of the first half-arm (23) and opening on one side in the tubular cavity (25) and on the other outside the first half-arm (23).

5. The infrared vision equipment according to claim 1, wherein the first part (20a) comprises a first lattice (40a) extending from the first frame (21a) along the connecting direction (X) and the second part (20b) may comprise a second lattice (40b) extending from the second frame (21b) along the connecting direction (X).

6. The infrared vision equipment (1) according to claim 5, wherein the first lattice (40a) and the second lattice (40b) are disjoint.

7. The infrared vision equipment (1) according to claim 5, wherein the first lattice (40a) and the second lattice (40b) are connected to each other by a plurality of flexible blades (41).

8. An additive manufacturing process for the connecting element (10) of the infrared vision equipment (1) according to claim 1, the process comprising the following steps:
producing (E1) by additive manufacturing the first part (20a) and the second part (20b) of the connecting element (10),
injecting (E2) the elastomer (30) in the tubular cavity (25) between the first half-arm (23) and the second half-arm (24).

9. The process according to claim 8, comprising, following the injection (E2) of the elastomer (30), a step of separation (E3) of an initial lattice of the connecting element extending between the first frame (21a) and the second frame (21b), into a first lattice (40a) of the first part (20a) extending from the first frame (21a) along the connecting direction (X) and a second lattice (40b) of the second part (20b) extending from the second frame (21b) along the connecting direction (X).
